(19) United States
(12) Patent Application Publication
(10) Pub. No.: US 2011/0039033 A1
(43) Pub. Date: Feb. 17, 2011

(54) METHOD OF DEPOSITING A POLYMER MICROPATTERN ON A SUBSTRATE

(76) Inventors: Erika Merschrod, St. John's (CA); Ning Su, St. John's (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/865,441

(22) PCT Filed: Feb. 2, 2009
(86) PCT No.: PCT/CA2009/000112

§ 371 Date: Nov. 3, 2010

Related U.S. Application Data
(60) Provisional application No. 61/025,108, filed on Jan. 31, 2008.

(51) Int. Cl. B05D 5/00

(52) U.S. Cl. 427/511; 427/256; 427/287

(57) ABSTRACT

A method for the direct construction of micropatterned devices using polymeric materials is disclosed. In particular, the present invention relates to a method of depositing a thermocurable or photocurable polymer micropattern on a substrate.

### FIELD OF THE INVENTION

The invention relates to a method for the direct construction of micropatterned devices using polymeric materials. In particular, the present invention relates to a method of depositing a thermocurable or photocurable polymer micropattern on a substrate.

### BACKGROUND OF THE INVENTION

Microcontact printing is a type of “soft lithography” in which a material of interest is inked onto a micropatterned rubber stamp. The stamp is then pressed onto a substrate, transferring the material in a particular pattern.

Microfabrication methods based on technology developed for the semiconductor industry typically involve the deposition, patterning, and removal of layers of silicon, silicon oxide, silicon nitride, metals and resin resists.¹

Existing methods for creating microscale or nanoscale features in devices involve several steps and use expensive equipment requiring cleanroom facilities. For example, to create a polymer-based microfluidic device one might need to spin-coat the polymer, mask it, selectively etch away components, and then remove the masking material. Alternatively, the components could be prepared with a sacrificial material, the polymer deposited on top, and then the sacrifical layer removed to leave the polymer structures.² Finally, a photocurable polymer could be deposited and selectively cured with photolithographic or holographic techniques, with removal of the uncured polymer to leave the desired polymer components.³ One polymer-specific method involves the inherent segregation of block co-polymers, where the large-scale pattern is governed by photolithography and the small-scale pattern is determined by the phase morphology of the copolymer.⁴ These methods could require several iterations to create a full, three-dimensional device.

As microfabrication and nanotechnology make inroads into biological and medical fields, the materials involved have been adapted to suit these new applications. Polymers (and even biopolymers) play a larger role, requiring gentler processing conditions such as lower temperatures and less extreme pHs. Many methods of microfabrication operate under less harsh conditions and fall under the general label of “soft lithography”.^{1,5}

The general idea behind most soft lithography techniques is to transfer a continuous layer of compound to a surface, to selectively protect (mask) the underlying material against subsequent steps, or to selectively remove the underlying material by displacement or by chemical reaction/solvation. This approach shows several benefits over traditional microfabrication. Once the initial micropattern is created in some kind of mold, the subsequent fabrication of the stamp and the application of the stamp to patterning other materials does not necessarily require the use of a cleanroom or expensive microfabrication equipment. However, this approach still requires several steps to create micropatterns in the underlying material (deposition of the material, stamping of the pattern, development of the pattern, and possibly removal of stamped mask).

For a potentially more direct method, it is possible to create a mold for each component which could be replicated with polymer casting. Microinjection molding and MIMIC are two approaches for polymer casting.^{6,7} The difficulty lies in assembling the polymer components into a device, using various polymer adhesion methods such as exposure to oxygen plasma, ultraviolet light, heat or some combination thereof. This method suffers from the errors inherent in aligning the different components and the time spent in assembly. For a monolithic device a single micromolding step would be possible, but the device design is limited by the complexity involved in creating the initial mold.

A final approach to microfabrication printing is “nanotransfer printing” in which thin metal structures are microfabricated on a block and then deposited onto a new substrate.⁸ This method is limited to certain classes of materials and requires extensive processing to create the microscale metal structures to be transferred.

There remains a need for the direct construction of micropatterned devices using polymeric materials which operates under gentle conditions.

### SUMMARY OF THE DISCLOSURE

The invention provides a method for the direct construction of micropatterned devices using thermocurable or photocurable polymers.

Accordingly, the present disclosure includes a method of depositing a polymer micropattern on a substrate, comprising:
a) applying a polymer composition to a stamp having a stamp micropattern thereon, so that the stamp micropattern is coated with the polymer composition;
b) contacting the stamp with a substrate and transferring the polymer composition from the stamp micropattern to the substrate, wherein the transferred polymer has a viscosity sufficient to form an uncured polymer micropattern comprising one or more uncured three-dimensional polymer features on the substrate, the uncured polymer micropattern corresponding to the stamp micropattern; and
c) curing the uncured polymer micropattern to form a cured polymer micropattern comprising one or more cured three-dimensional polymer features.

In an embodiment of the present disclosure, the polymer composition has a viscosity of about 1,000 cps to about 15,000 cps. In a subsequent embodiment, the polymer composition has a viscosity of about 5,000 cps to about 10,000 cps. In another embodiment, the polymer composition has a viscosity of at least 1,000 cps, optionally 2,500 cps, optionally 5,000 cps.

In another embodiment of the disclosure, the stamp micropattern comprises raised contact surfaces on the stamp for receiving polymer thereon for the formation of the corresponding three-dimensional polymer features.

In another embodiment, the stamp micropattern comprises recesses for receiving polymer therein for the formation of the corresponding three-dimensional polymer features.

In an embodiment of the disclosure, the three-dimensional polymer features comprise micro-scale or nano-scale features. In a subsequent embodiment, the micro-scale or nano-scale features comprise channels, reservoirs, valves, inlet/outlet/access ports, protrusions and constrictions or filters. In a further embodiment, the micro-scale or nano-scale features comprise a cross-hatch pattern.

In a further embodiment, the channels have a height of about 10 nm to about 100 μm, optionally about 10 nm to about 100 nm.

In another embodiment of the disclosure, the channels have a width of about 1 μm to about 100 μm, optionally about 10 μm to about 50 μm.

In a further embodiment, the channels comprise channel walls and the channel walls have a width of about 1 μm to about 500 μm, optionally about 10 μm to about 100 μm.

In another embodiment, the reservoirs have a height of about 100 nm to about 10 μm. In an embodiment, the reservoirs have a volume of about 1 μm³ to about 100 μm³.

In another embodiment of the disclosure, the valves comprise a polymer layer having a closed position in which the layer blocks and seals a passage to channel and an open position in which the passage to the channel is open. In an embodiment, the valves have a height of about 10 nm to about 500 μm. In another embodiment, the valves have a height of about 10 nm to about 100 nm. In an embodiment, the polymer layer which blocks or opens passage to the channel is about 10 nm to about 100 nm thick.

In another embodiment, the access port comprises an opening, wherein the opening comprises an inner diameter and the diameter is about 10 μm to about 1 mm.

In another embodiment, the protrusions form filters or constrictions wherein the protrusions are formed randomly or are spaced in a controlled order. In a further embodiment, the filter protrusions have a height of about 10 nm to about 100 nm and a width of about 100 nm to about 1 μm. In another embodiment, the constriction protrusions have a height of about 100 nm to about 500 nm and a width of about 1 μm an to about 10 μm.

In an embodiment of the disclosure, the polymer composition of the method comprises thermocurable or photocurable polymers.

In an embodiment of the disclosure, the thermocurable polymer comprises a silicone-based polymer. In an embodiment, the thermocurable silicone-based polymer comprises a thermocurable silicone elastomer or a silicone gel. In a further embodiment, the silicone-based polymer comprises a mixture of methylhydrogen siloxane dimethyl, dimethylvinyl-terminated dimethyl siloxane, dimethylvinylated and trimethylated silica, tetra(trimethylsiloxy) silane and tetramethyl tetravinyl cyclotetrasiloxane or a mixture of dimethylvinyl-terminated dimethyl siloxane, hydrogen-terminated dimethyl siloxane, silicate and trimethylated silica.

In another embodiment of the disclosure, the photocurable polymer comprises an acrylate or a silicone elastomer. In another embodiment, the acrylate comprises methacrylate. In a further embodiment, the silicone elastomer comprises a mixture of a siloxane pre-polymer, mercaptosiloxane and hydroxymethylphenyl propanone.

In another embodiment of the disclosure, steps a)-c) are repeated on the same substrate. In a further embodiment, steps a)-c) are repeated on the same substrate with a second polymer composition to form a second polymer micropattern. In another embodiment, the second polymer composition and/or the second polymer micropattern are the same or different as the polymer composition and the polymer micropattern used in the first steps.

In an embodiment of the disclosure, the substrate is a glass slide, silicon wafers, polycarbonate Petri dishes, silicone elastomers, another polymer film or micropatterned polymeric devices fabricated in silicon, glass or polymer.

In another embodiment of the disclosure, about 1 to about 30 mg of the polymer composition is applied to the stamp. In a subsequent embodiment of the disclosure, about 20 mg of the polymer composition is applied to the stamp.

In a subsequent embodiment of the disclosure, the contacting of the stamp with the substrate comprises pressing of the stamp with a force of about 1 Newton to about 10 Newtons. In another embodiment, the pressing of the stamp comprises a force of about 5 Newtons.

In an embodiment of the disclosure, the transferring of the polymer composition comprises a time of about 30 seconds to about 5 minutes. In another embodiment, about 1 mg of the polymer composition is transferred during the transfer process.

In an embodiment of the disclosure, the thermocurable polymer is cured at a temperature of about 10° C. to about 150° C. In a subsequent embodiment, the thermocurable polymer is cured at a temperature of about 60° C. to about 90° C., for a period of about 40 minutes to about 1 hour.

In an embodiment, the photocurable polymer is cured in the presence of a photoinitiator and exposed to ultraviolet light having a wavelength of about 200 nm to about 400 nm. In a subsequent embodiment of the disclosure, the photocurable polymer is exposed to ultraviolet light for a period of about 5 to about 15 minutes. In a further embodiment, the photoinitator is benzophenone or hydroxymethylphenyl propanone.

In another embodiment of the disclosure, the polymer micropattern on the substrate comprises a micropatterned polymeric device.

In another embodiment of the disclosure, the substrate with a deposited micropattern produced in accordance with the method of present disclosure can be used as a device in environmental assays, chemical assays, biological assays and medical assays.

In another embodiment of the disclosure there is included a method of conducting an environmental assay, chemical assay, biological assay or medical assay comprising,
a) providing a substrate coated with a cured polymer micropattern produced in accordance of an embodiment of the method of the present disclosure,
b) contacting the micropattern with an environmental sample, chemical sample, biological sample (cells, tissues, biological fluids) or medical sample (cells, tissues or fluids (blood, lymph etc.) from a subject, such as a human, wherein the polymer micropattern is capable of retaining a target compound,
c) determining the presence or absence of the target compound in the micropattern.

In a further embodiment, the presence or absence of the target compound in the micropattern is determined by:
a) contacting the micropattern with a trap compound that reacts with or binds to the target compound to produce a reaction product or bound target compound, and
b) determining the presence or absence of the reaction product or bound target compound, wherein the presence of reaction product or bound target is indicative of the presence of the target compound in the sample.

In another embodiment of the present disclosure, there is included a method of conducting an environmental assay, chemical assay, biological assay or medical assay comprising,
a) providing a substrate coated with a cured polymer micropattern produced in accordance of an embodiment of the method of the present disclosure, wherein the micropattern is impregnated with a trap compound that reacts with or binds to a target compound,
b) contacting the micropattern with an environmental sample, chemical sample, biological sample or medical sample, wherein the target compound of interest reacts with or binds to the target compound to produce reaction product or bound target compound,
c) determining the presence or absence of the reaction product or bound target compound wherein the presence of reaction product or bound target is indicative of the presence of the target compound in the sample.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

Embodiments of the invention will be described in relation to the drawings in which:

FIG. 1 is a schematic representation of an embodiment of the method of the present disclosure;

FIG. 2 is an atomic force micrograph showing the edge of a feature produced in accordance of an embodiment of the method of the present disclosure;

FIG. 3 is a cross section of the edge of FIG. 2 taken with an atomic force microscope;

FIG. 4 is a micrograph showing a cross-hatch pattern of features using a low-viscosity polymer produced in accordance of an embodiment of the method of the present disclosure;

FIG. 5 is a graph illustrating the height of the cross-hatch pattern of FIG. 4 using low-viscosity and high-viscosity polymers produced in accordance with an embodiment of the method of the present disclosure; and

FIG. 6 is a schematic representation of a three-channel device in which each channel has an adhesive coating for a different analyte produced in accordance with an embodiment of the method of the present disclosure.

### DETAILED DESCRIPTION

The invention provides a method for the direct construction of micropatterned devices using thermocurable or photocurable polymers.

Accordingly, the present disclosure includes a method of depositing a polymer micropattern on a substrate, comprising:
a) applying a polymer composition to a stamp having a stamp micropattern thereon, so that the stamp micropattern is coated with the polymer composition;
b) contacting the stamp with a substrate and transferring the polymer composition from the stamp micropattern to the substrate, wherein the transferred polymer has a viscosity sufficient to form an uncured polymer micropattern comprising one or more uncured three-dimensional polymer features on the substrate, the uncured polymer micropattern corresponding to the stamp micropattern; and
c) curing the uncured polymer micropattern to form a cured polymer micropattern comprising one or more cured three-dimensional polymer features.

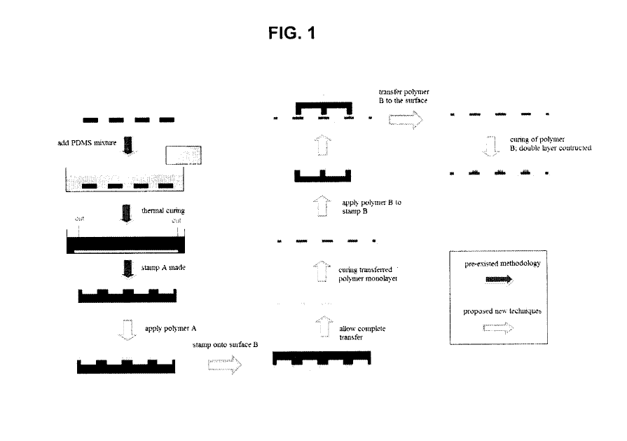

In an embodiment of the disclosure, micropatterned stamps are produced in accordance with methods well known in the art.^{1,5,9} As exemplified in FIG. 1, a typical method comprises pouring a silicone polymer, such as polydimethylsiloxane, into a mold which contains a raised pattern. It will be understood by one skilled in the art that the pattern will correspond to the inverse of the micropatterned stamp. The mold can also be formed with recesses. The mold is optionally produced by laser or inkjet printing, by photolithography, or by electron-beam or scanning-probe lithography. When laser or inkjet printing is utilized, a pattern is printed onto an acetate sheet using a commercial laser or inkjet printer. The pattern can be created using standard drawing software. The raised toner or ink on the acetate sheet defines the features and creates the mold.¹⁰ When photolithography is used to create the mold, a photoactive film is deposited onto a substrate.¹ By irradiating the film with light through a patterned photomask, the photoactive film is selectively removed and the pattern is transferred to the photoactive film. The resulting features form the mold, or the pattern is then transferred to the substrate through etching through the photoactive film mask and then the mold is created on the substrate. Electron beam lithography is analogous to photolithography, but the film is exposed to an electron beam instead of light.¹ When scanning-probe lithography is utilized to form the mold, a film is deposited on a substrate. A scanning-probe instrument such as (but not limited to) an atomic force microscope is used to physically or chemically “write” a pattern into the film.¹ For example, this may involve a physical removal of portions of the film by scratching with a sharp tip on a scanning probe. The resulting patterned film forms the mold.

In another embodiment, the method of the present disclosure is utilized to form the micropatterned stamp. In this embodiment, an initial pattern is produced using standard methods known in the art such as lithographic or printing methods described above. This stamp is then used to stamp PDMS features. The PDMS features are then used as the pattern for subsequent stamping of features. The polydimethylsiloxane which forms the initial stamp is cured at a temperature of about 20° C. to about 90° C. for a time of about 40 minutes to several days. It will be understood by those in the art that a curing temperature of about 20° C. will take a significant period of time and is not necessary as heating the polymer does not cause harm. In an embodiment, the polydimethylsiloxane is cured at a temperature of about 60° C. to about 90° C. for a time of about 40 minutes to about one hour. It will also be understood by those in the art that once the polydimethylsiloxane is firm, the curing process is complete. The cured polydimethylsiloxane is then peeled from the mold and is used as a micropatterned stamp.

In an embodiment of the disclosure, the micropatterned stamps have a surface area of about 0.1 cm² to about 100 cm². Stamps possessing a surface area of about 0.1 cm² will need to be manipulated with tweezers or a robotic arm. Stamps with areas as large as 100 cm² will need to be supported on a holder to allow for even stamping by the user or by machine. It will be known to those skilled in the art that micropatterned stamps having metre long dimensions could also be manufactured. However, a stamp of this size (having more than meter long dimensions) would be of limited use due to its large size and the difficulty of applying firm pressure evenly to the whole of the stamp. In a subsequent embodiment, the micropatterned stamp has a surface area of about 1 cm². A stamp having a surface area of about 1 cm² is easily manipulated by hand. In an embodiment, a stamp having a surface area of about 1 cm² possesses a mass of about 0.1 grams. The method of producing a micropatterned stamp is well known in the art and will be known to a person skilled in the art and is described above.

In an embodiment of the present disclosure, steps a)-c) are repeated on the same substrate with a second polymer composition to form a second deposited polymer micropattern on the same substrate. When steps a)-c) are repeated, the second polymer composition and the second polymer micropattern can be the same or different as the first polymer composition and the first polymer micropattern. Steps a)-c) can also be repeated numerous times to form a substrate having more than two deposited micropattern layers. In an embodiment, when a second or further micropattern is deposited on the same substrate, the micropatterns optionally partially overlap, such that a first polymer micropattern feature, such as a line, and a second micropattern features, such as a line, may intersect. In another embodiment, the first and second or further micropatterns have pattern features that are abutting, for example, where the end of a first micropattern polymer line may abut a second or further micropattern polymer line. In a subsequent embodiment, the first and second or further micropatterns have lines or other features that are optionally adjacent to one another, opposed to one anther or spaced apart, for example, spaced apart by at least 10 nm, 100 nm, 1 μm, 10 μm or 100 μm.

In an embodiment of the disclosure, the polymer composition can be applied to the micropatterned stamp, using for example, a glass pipette. Generally, disposable glass pipettes supplied, for example by Fisher Scientific®, are used to apply the polymer composition to the micropatterned stamp. In another embodiment, a micropipettor is used to apply the polymer. It will be known to those skilled in the art that the viscosity of the polymer composition will dictate how large the opening of the pipette should be to be able to apply the polymer. For example, when the viscosity of the polymer composition is low, the end of the pipette that has a 1 mm opening will effectively apply the polymer to the stamp. Conversely, when the viscosity of the polymer composition is higher and doesn't flow as well, the opposite end of the pipette with an opening of 5 mm is used. When the 5 mm opening is used, the polymer composition is scooped with the opening and applied to the stamp.

In an embodiment of the disclosure, the polymer composition of the method comprises thermocurable or photocurable polymers. In another embodiment of the disclosure, the thermocurable polymer is a silicone-based polymer. In a subsequent embodiment, the thermocurable polymer is a thermocurable silicone elastomer or silicone gel. In a further embodiment, the silicone-based polymer is a mixture of substituted siloxanes, substituted silica and substituted silanes. In a subsequent embodiment, the silicone-based polymer is Sylgard® 184 (Dow Corning®) polymer or Type 3-4207 polymer (Dow Corning®). It will be known to those skilled in the art that Sylgard® 184 polymer is a mixture of methylhydrogen siloxane dimethyl, dimethylvinyl-terminated dimethyl siloxane, dimethylvinylated and trimethylated silica, tetra(trimethylsiloxy) silane, and tetramethyl tetravinyl cyclotetrasiloxane and Type 3-4207 polymer is a mixture of dimethylvinyl-terminated dimethyl siloxane, hydrogen-terminated dimethyl siloxane, silicate and trimethylated silica, as reported by the manufacturer on the Materials Data Safety Sheets.

In another embodiment of the disclosure, the photocurable polymer is selected from an acrylate or a silicone elastomer. In a subsequent embodiment, the acrylate is methacrylate. In a further embodiment, the silicone elastomer is a mixture of siloxanes and mercaptosiloxanes. In another embodiment, the silicone elastomer is Type 3-6371 (Dow Corning®) polymer which is a mixture of siloxane pre-polymer, mercaptosiloxane, and hydroxymethylphenyl propanone. A person skilled in the art would understand that a siloxane prepolymer is a polymer or oligomer with a backbone comprised of alternating silicon and oxygen atoms, which is then further polymerized or crosslinked to form the siloxane polymer.

In an embodiment of the disclosure, the viscosity range of the polymer compositions have a viscosity sufficient to form an uncured polymer micropattern on the substrate. Accordingly, the viscosity of the polymer compositions is such that the coated stamp can faithfully transfer the uncured micropattern to the substrate without significant loss of the three-dimensional features of the micropattern. In a subsequent embodiment, the polymer compositions have a viscosity of about 1,000 to about 15,000 centipoise (cps). In a subsequent embodiment, the polymers used in the present method have a viscosity of about 5,000 to about 15,000 cps. In a further embodiment, the polymers used in the present method have a viscosity of about 10,000 to about 15,000 cps. In an embodiment of the disclosure, the polymer compositions have a viscosity of at least 1,000 cps. In another embodiment, the polymer compositions have a viscosity of at least 2,500 cps. In a subsequent embodiment, the polymer compositions have a viscosity of at least 5,000 cps. In a subsequent embodiment, the polymer compositions have a viscosity of at least 10,000 cps. A person skilled in the art would recognize that polymer compositions possessing a viscosity higher than 15,000 cps begin to lose liquid properties and become difficult to use in the method of the present disclosure. The viscosity of the polymer Sylgard® 184 is about 5,000 cps. It will be known to a person skilled in the art that the viscosity of a thermocurable polymer can be increased by initial thermal curing or also by solvent evaporation.

In an embodiment, the limit of the micro-scale or nano-scale feature sizes of the micropatterns produced in accordance with the method of the present disclosure is dependent upon the method used for the fabrication of the initial micropattern. It will be understood by those skilled in the art that a micro-scale feature is one having a size ranging from 1 μm to about 500 μm. In addition, a nano-scale feature would be understood by a person skilled in the art as having a size ranging from 10 nm to about 1000 nm. For example, if inkjet printing is used for fabrication of the initial pattern, the feature size can be as small as 10 μm. If photolithography is used for fabrication of the initial pattern, the feature size can be as small as 1 μm, while the feature size can be on the order of tens of nanometers if electron-beam or scanning-probe lithography is used. In another embodiment, the limit of the feature sizes will also be dependent on the viscosity of the polymer used. For example, feature sizes on the order of 10 μm have been obtained using polymers having a viscosity of 1,000 cps. However, very fine structural features fabricated with the method of the present disclosure will likely run together if the viscosity of the polymer is very low. Accordingly, it will be understood by those skilled in the art that a polymer with a higher viscosity allows for a higher resolution of micropattern transfer. For example, it has been observed that polymers having a viscosity of about 15,000 resist flow, and therefore better preserve the structural features during micropattern transfer. The transferred pattern is deformable and malleable until it is cured but has significant viscosity to retain its three dimensional structural features.

In an embodiment of the disclosure, the stamp having a stamp micropattern has raised contact surfaces on the stamp for receiving the polymer composition thereon. In another embodiment, the stamp having a stamp micropattern has recesses for receiving the polymer composition therein. It will be understood by those skilled in the art that areas where the stamp micropattern does not have raised contact surfaces or recesses, comprise support areas for the stamp micropattern. In a further embodiment, the raised contact surfaces or the recesses of the stamp micropattern are coated with a polymer with a viscosity sufficient to form an uncured polymer micropattern when transferred to the substrate. It will be understood by those skilled in the art, that the raised contact surfaces and the recesses of the stamp micropattern will correspond to the uncured polymer micropattern that is transferred to the substrate. The uncured polymer micropattern comprise one or more uncured three-dimensional features. For example, when certain raised contact surfaces comprise the stamp micropattern, corresponding channels and reservoirs are formed on the substrate. Similarly, for example, when recesses comprise the stamp micropattern, corresponding protrusions are formed on the substrate. It will be understood by those skilled in the art that due to solvent evaporation, as well as the polymerization or cross-linking reactions of the uncured polymer as it is cured, the cured polymer will shrink by a small amount. Therefore, the cured polymer micropattern comprising one or more cured three-dimensional polymer features will be fractionally smaller in size than the uncured polymer micropattern.

In an embodiment, the cured three-dimensional polymer features that are created with the method of present disclosure have micro-scale and nano-scale dimensions. In an embodiment of the present disclosure, when the stamp micropattern comprises raised surfaces, the corresponding cured three-dimensional micro-scale and nano-scale features include channels, reservoirs, valves and access ports. Channels direct a fluid to flow through the channel. In an embodiment of the present disclosure, the channels have a height of about 10 nm to about 100 μm. In a further embodiment, the channels have a height of about 10 nm to about 1 μm. In a subsequent embodiment, the channels have a height of about 10 nm to about 100 nm. In another embodiment, the channels have a width of about 1 μm to about 100 μm. In a further embodiment, the channels have a width of about 1 μm to about 75 μm. In a subsequent embodiment, the channels have a width of about 1 μm to about 50 μm. In an embodiment of the present disclosure, the channels comprise channel walls and the channel walls have a width of about 1 μm to about 500 μm. In a further embodiment, the channels walls have a width of about 1 μm to about 200 μm. In a subsequent embodiment, the channels walls have a width of about 10 μm to about 100 μm. It will be apparent to those skilled in the art that the total length of the channels is limited by the size of the whole micropattern. In an embodiment, the length of the channels ranges from about 1 μm to about 10 mm.

In an embodiment of the disclosure, when the cured three-dimensional feature is a reservoir, the reservoirs have a height of about 100 nm to about 10 μm. In a further embodiment, the reservoirs have a height of about 100 nm to about 1 μm. Reservoirs are able to hold liquids within their walls, and in an embodiment, the reservoirs have a volume of about 1 μm³ to about 100 μm³. In an embodiment, reservoirs have a length and/or width of about 1 μm to about 100 μm.

In an embodiment of the present disclosure, when the cured three-dimensional feature is a valve, the valve will have similar dimensions to the channel for which they are associated with. In an embodiment, the valves comprise a polymer layer having a closed position in which the layer blocks and seals a passage to channel and an open position in which the passage to the channel is open. In an embodiment, the thickness of the polymer layer of the valve is about 10 nm to about 100 nm thick. In another embodiment, the valves have a height of about 10 nm to about 500 μm. In a further embodiment, the valves have a height of about 10 nm to about 1 μm. In a subsequent embodiment, the valves have a height of about 10 nm to about 100 nm.

In another embodiment of the disclosure, the cured three-dimensional feature is an access port. Access ports provide a connection between the micropattern and other instrumentation such as a spectrophotometer. If the access port allows fluid to enter the micropattern, it is an inlet port, while if fluid flows out of the access port, it is an outlet port. In an embodiment of the disclosure, the access ports have openings, wherein the inner diameter is about 10 μm to about 1 mm across.

In another embodiment of the present disclosure, when the stamp micropattern comprises recesses, the corresponding cured three-dimensional micro-scale and nano-scale features include protrusions. Depending on the size and spacing of the protrusions, the protrusions act either as a filter to filter certain components from a flow of liquid, or act as a constriction to constrict the flow of a liquid. In an embodiment, the protrusions are spaced randomly or are spaced in a controlled order. In another embodiment of the present disclosure, the filters have a height of about 10 nm to about 100 nm and a width of about 100 nm to about 1 μm. In a subsequent embodiment, the filter protrusions have a height of about 10 nm to about 100 nm and a width of about 100 nm to about 1 μm. In another embodiment, the constriction protrusions have a height of about 100 nm to about 500 nm and a width of about 1 μm to about 10 μm. Protrusions will typically cover a surface area of the micropattern of about 1 μm² to about 10 mm².

In another embodiment of the disclosure, the stamp micropattern comprises a cross-hatch pattern, which comprises a series of vertical and horizontal walls intersecting with each other, to form a series of reservoirs and corresponding protrusions where the walls intersect. In an embodiment, the cross-hatch pattern comprises recesses which are able to act as reservoirs to hold liquid. In another embodiment, the cross-hatch pattern also comprises protrusions which can act as described above, either as a filter to filter (remove) certain components from a flow of liquid, or act as a constriction to constrict (reduce or block) the flow of a liquid. In another embodiment, the cross-hatch pattern creates a texture which increases the surface area of the micropattern, and accordingly, increases the sensitivity of the micropattern when used for analytical/sensor applications.

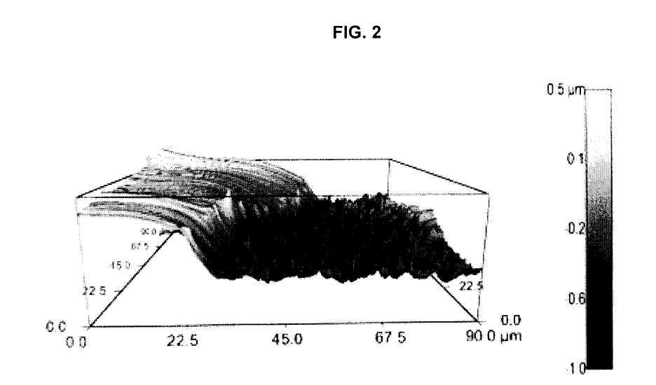

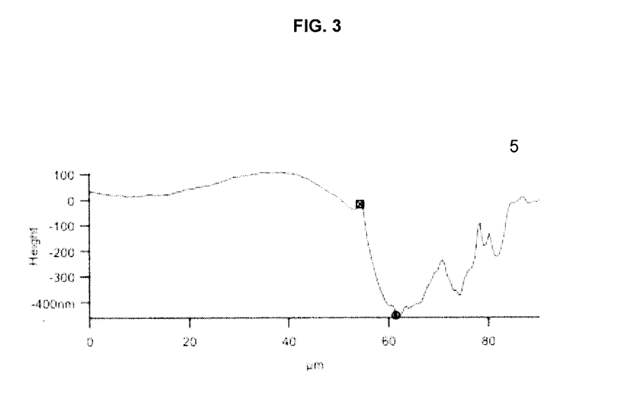

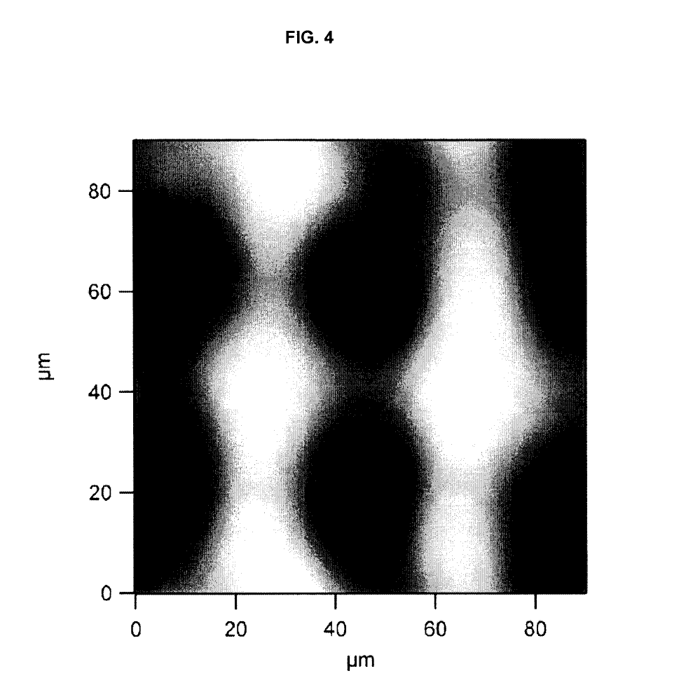

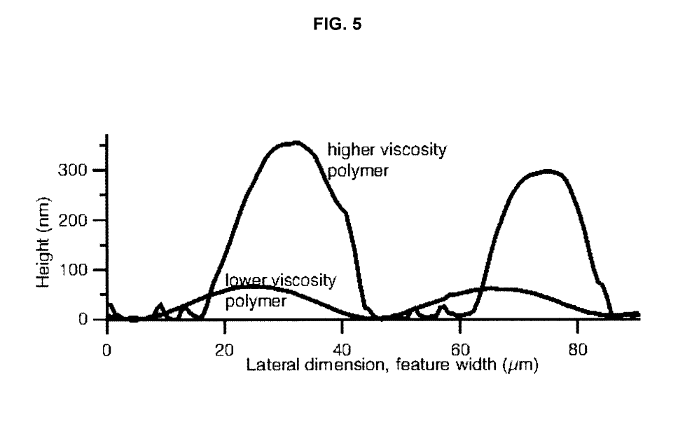

In an embodiment of the disclosure, the height of the cured polymer micropattern is controlled by the viscosity of the polymer composition. Accordingly, the viscosity of the polymer has the effect of determining the height of the features of the micropattern. In another embodiment, a polymer with a higher viscosity will result in a polymer micropattern having a higher lateral resolution. For example, polymers having a viscosity of 1,000 cps result in a height of about 100 nm of the polymer micropattern. A polymer having a viscosity of 15,000 cps results in a height of about 300 nm of the polymer micropattern. The atomic force micrograph of FIG. 2 shows the edge of a feature produced in accordance with the method of the present disclosure. FIG. 3 is a cross-sectional profile of FIG. 2 which shows a height of 430 nm for this feature. FIG. 4 shows an atomic force micrograph of a cross-hatch micropattern produced in accordance of an embodiment of the method of the present disclosure. FIG. 5 shows the cross-sectional profile showing the height and width of the features of the micropattern in FIG. 4, using both the low-viscosity polymer of FIG. 4 and a high-viscosity polymer. Accordingly, in an embodiment as shown in FIGS. 4 and 5, the features of the micropattern produced using a low-viscosity polymer have a height of about 75 nm and a width of between about 30 and 40 μm, while the corresponding features of the micropattern using a high-viscosity polymer have a height of about 350 nm, and a narrower width of between about 20 and 30 μm, demonstrating that a higher viscosity polymer results in higher features and a higher resolution of those features.

The relation of the viscosity of the polymer to the height of the polymer micropattern is not a linear relationship. Without being bound by theory, it appears that during transfer of the polymer composition to the substrate, only a thin layer of polymer is transferred off the bottom of the stamp and not the entirety of the polymer, which therefore allows for multiple transfer with a single inking of polymer. The transfer of the polymer from the stamp to the substrate involves the establishment of polymer-substrate interaction and simultaneously the disruption of polymer-polymer interactions. For polymers possessing a high viscosity, the disruption occurs at a point further from the surface of the polymer, resulting in a thicker layer of polymer being stamped on the substrate. Conversely, if the polymer possesses a lower viscosity, the disruption occurs at a point closer to the surface of the polymer, resulting in a thinner layer of polymer being stamped on the surface, as evidenced by the graph in FIG. 5. Without being bound by theory, it is thought that low viscosity polymers have a lower polymer-polymer disruption point and break sooner when the stamp is removed from the substrate.

In an embodiment of the present disclosure, about 1 mg to about 30 mg of the polymer composition is applied to the stamp having a surface area of about 1 cm². In a subsequent embodiment, about 20 mg of polymer is applied to a stamp having a surface area of about 1 cm². It will be understood by a person skilled in the art that as the size of the stamp increases, there will be a corresponding increase in the amount of polymer composition that is applied to the stamp. When preparing the micropatterned stamp for transfer of the polymer, the stamp can be blotted once or twice by stamping onto a piece of glass or any clean solid surface to remove excess polymer. After blotting, the stamp is ready for transfer of the polymer composition, where about 1 mg of polymer will be transferred each time the stamp, having a surface area of about 1 cm², is applied to the substrate. Again, the amount of polymer composition that is transferred to the substrate will be dependent upon the size of the stamp. In an embodiment, a stamp can be stamped about three times, but it will be understood by a person skilled in the art that the number of stampings will be dependent upon the polymer. Without being bound by theory, the polymer that has been applied to the stamp possesses interactions with the stamp which are difficult to disrupt. Therefore, as the polymer is repeatedly stamped, it becomes more difficult for the polymer to be transferred to the substrate, at which point the stamp would need another application of polymer.

In another embodiment of the present disclosure, the transfer of the polymer composition comprises:
a) contacting the stamp with the substrate;
b) pressing the stamp on the substrate;
c) allowing the stamp to remain without applied pressure; and
d) removing the stamp.

In an embodiment of the disclosure, the placing of the stamp results in a force of about 1 Newton across a stamp having a surface area of about 1 cm². Generally, the placing of the stamp on the substrate is carried out by hand. Included within the scope of the disclosure are mechanical means to place the stamp and transfer the polymer to a substrate, for example, a robotic arm. For instance, a clamp holding the micropatterned stamp and attached to a metal rod is used to stamp the substrate with the micropatterned stamp. The rod is attached to a motor which can oscillate the clamp from a stamping position where polymer is applied to a non-stamping position.

In a subsequent embodiment of the disclosure, the pressing of the stamp comprises a force of about 1 to about 10 Newtons. In another embodiment, the pressing of the stamp comprises a force of about 5 Newtons. When the force pressed upon the stamp is released, the mass of the stamp results in a force of about 0.001 Newtons.

In an embodiment of the disclosure, the placing of the stamp on the substrate takes about one second, while the pressing of the stamp also takes about one second. In an embodiment, the micropatterned stamp is allowed to remain on the substrate for about 30 seconds to about 5 minutes. It will be understood by those skilled in the art that to obtain the desired three-dimensional polymer features, the transfer time of the polymer will need to be optimized for each different polymer. It has been determined that longer transfer times increase the amount of polymer that is transferred from the stamp to the substrate. However, regardless of the polymer that is utilized, additional polymer transfer is negligible after about 5minutes of transfer.

In an embodiment of the disclosure, the substrate to which the polymer is applied can be any material which is harder than the stamp and which the polymer will adhere to. For example the substrate may be a glass slide, a quartz slide, a silicon wafer which may or may not have an oxide, nitride or polysilicon layer, polycarbonate Petri dishes, silicone elastomers which have been cured harder than the polymer composition that is transferred from the stamp or another polymer film. In an embodiment of the disclosure, the substrate is a micropatterned device which has been fabricated by other methods and is fabricated in silicon, glass or polymer. In this embodiment, additional three-dimensional polymer features are deposited in accordance with the method of present disclosure on a device which has been fabricated by other methods. In addition, as steps a)-c) of the method can be repeated, the substrate can also be the same substrate that has been used in steps a)-c) to form a substrate comprising more than one deposited polymer micropattern.

In an embodiment of the disclosure, when a thermocurable polymer is used, the uncured polymer micropattern is cured at a temperature sufficient to effect curing to form a cured polymer micropattern comprising one or more cured three-dimensional features. In another embodiment, the thermocurable polymer is cured at a temperature of about 10° C. to about 150° C. for a period of about 40 minutes to a period of days. In a subsequent embodiment, the thermocurable polymer is cured at a temperature of about 60° C. to about 90° C. for a period of about 40 minutes to about 1 hour. It will be understood by those skilled in the art that curing a polymer at lower temperatures, such as about 10° C., will take a much longer period of time than at higher temperatures.

In a subsequent embodiment of the disclosure, when a photocurable polymer is used, the uncured polymer micropattern is cured in the presence of a photoinitiator and exposed to ultraviolet light having a wavelength of about 200 nm to about 400 nm to form a cured polymer micropattern comprising one or more cured three-dimensional features. In a subsequent embodiment of the disclosure, the photocurable polymer is exposed to ultraviolet light for a period of about 5 to about 15 minutes. In another embodiment of the disclosure, the photoinitiator is benzophenone or hydroxymethylphenyl propanone.

In another embodiment of the disclosure, the method is used to make polymer micropatterns on a substrate, which are then used as devices possessing three-dimensional micro-scale or nano-scale features such as channels, reservoirs, valves, protrusions, cross-hatching etc. These devices are then used to collect a sample from an environment, and either separate, concentrate or selectively adsorb certain analytes from the sample. These analytes can subsequently be identified and quantified simultaneously by transducing the adsorption event, for example by optical or electrical signal. The micropatterned polymer device produced in accordance with the present disclosure can be used in environmental assays, biomedical assays and chemical assays. The micro-scale and nano-scale features of the micropatterned polymer devices lead to more interactions between the sample and the sensor and therefore results in a higher sensitivity of the device. Furthermore, the micro-scale and nano-scale features require small sample volumes which is an important consideration when performing frequent monitoring in sensitive areas or when collecting biomedical samples from patients.

In another embodiment of the present disclosure, the polymer compositions used in the fabrication of the devices are spiked with fluorescent dyes, magnetic or metallic particles and semi-conducting particles such as quantum dots. The only requirement for the addition of a dopant is that the particle size of the dopant be sufficiently smaller than the three-dimensional feature size being created. The addition of a dye for example, may allow different micropatterned devices fabricated in accordance with the method of the present disclosure to have different colors to allow easy recognition by the user. In another embodiment of the disclosure, a micropatterned device is doped with a dye which absorbs a particular wavelength of light to protect an analyte which flows through a channel of the micropatterned device. In a subsequent embodiment, a fluorescent dye or quantum dots are used as a dopant to illuminate a particular region of the micropatterned device to allow for spectroscopic measurement or to stimulate a photo-responsive process. In another embodiment, the dopants are magnetic particles which result in the micropatterned device possessing a magnetic field which allows for measurements on a certain region of a chip. In addition, a magnetic field could also serve to align or bind a magnetic analyte within a channel or also actuate a magnetoresistant component. In another embodiment, conducting polymers are used in the polymer compositions wherein to create features within the device for the purpose of making electrical measurements for detection of binding events.

In an embodiment of the disclosure, the polymer compositions used in the method are optionally functionalized and tailored for use in a particular environment. Different features of the polymeric device can be made from different polymers or can be functionalized differently. For example, one set of channels or reservoirs on the micropatterned polymeric device could be rendered more hydrophilic and another set more hydrophobic, therefore promoting the selective adsorption of more polar or less polar compounds in different regions of the device. Further, even with only topographical or structural variations in the device, sample collection with some separation of analytes will still occur based on the different migration times of the different analytes through the device. This process can subsequently be followed by detection through, for example, optical means, of an analyte of interest, therefore completing the sensing function of the device.

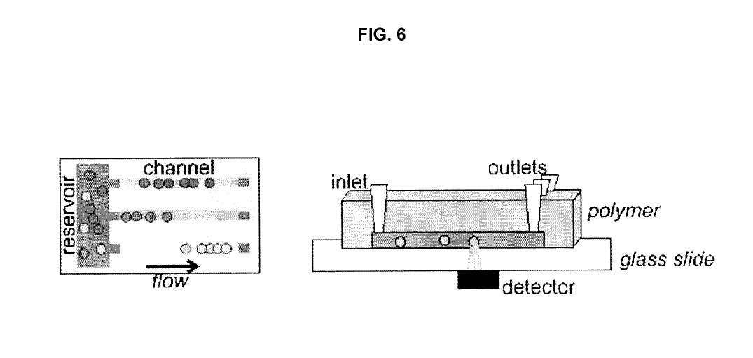

In an embodiment of the present disclosure, the devices made in accordance with the method of the disclosure are optionally used in environmental assays, chemical assays, biological assays and medical assays. The schematic representation in FIG. 6 illustrates a three-channel device in which each channel possesses an adhesive coating for a different analyte. When a sample is passed through the device, any binding that occurs in a given channel will result in a signal, for example an optical signal, at a detector.

The disclosure also includes a substrate or device comprising a cured polymer micropattern comprising one or more cured three-dimensional polymer features. Optionally, the substrate or device comprises a plurality of polymer micropatterns, such as a plurality of overlaid polymer micropatterns. The features optionally comprise micro-scale or nano-scale features, such as a channel, a reservoir, a valve and an access port. For example, the valve optionally comprises a polymer layer having a closed position in which the layer blocks and seals a passage to a channel and an open position in which the passage to the channel is open. The valve prevents fluid flow through the valve when it is in a closed position but allows fluid communication through the valve when it is in an open position. The features optionally comprise the heights and widths selected from the heights and widths as described herein. The micropatterns are optionally impregnated with a trap compound for use in assays as described herein to identify the presence of a target compound. The trap compound interacts with the target compound for example, by binding or reacting with the target compound. The presence of a reaction product or bound target indicates the presence of the target compound in the sample. The devices are used with an environmental sample, where the environmental sample includes soil, water or air. A chemical or biological sample includes cells, tissues and biological fluids, while a medical sample, cells, tissues or medical fluids such as blood, saliva, lymph etc.

Specifically, the polymeric devices of the present disclosure are useful for monitoring heavy metals in waste runoff at an industrial site. A device specifically tailored for detection of one or a group of heavy metals will indicate, based on a change in current between two electrodes, that a particular metal ion is present and at which concentration, when immersed in the effluent. If a specific metal is present, when it enters the device it will bind to an electrode within the device and undergo a redox reaction which will produce an electrical signal.

The polymeric device can also be used for monitoring fecal contamination of drinking water. The specifically tailored device will indicate through a color change that an indicator of human impact (such as caffeine) has entered the device. With frequent monitoring at many sites within the water system, one can then have an early warning of potential contamination which can be followed up with the longer and more costly bacterial culture tests.

The devices produced by the method of the present disclosure can also be used to identify the presence of a metabolic abnormality in saliva. The device collects the saliva and identifies (through signal transduction such as a spectrophotometric fingerprint) the presence of a chemical compound resulting from an incomplete or abnormal metabolic process. Elevated levels of certain compounds can serve as early warnings of certain diseases (e.g. sugar levels indicating diabetes). By using a polymeric device made in accordance with the present disclosure, the sensitivity of the assay is enhanced thus allowing for testing from low-concentration media such as saliva rather than blood. This allows for easier and safer monitoring.

The following non-limiting examples are illustrative of the present disclosure:

### EXAMPLES

### Reagents and Materials

Polymeric materials were obtained from Dow Corning (Sylgard 184, type 3-4207 thermal curable elastomer, type 3-6371 UV curable silicone elastomer) or Norland Optical (optical adhesives type 91, 74, 68 and 65). Masters were fabricated using standard lithographic methods on silicon wafers or by laser printing (Hewlett Packard) onto sheets of acetates (Hewlett Packard). The oven for thermal curing is from Mandel Scientific (Montreal, Canada), while the UV lamp for photocuring is from Newport (Connecticut, USA). Glass slides for substrates were purchased from Fisher Scientific.

Atomic Force Microscope (AFM) images were taken with an MFP-3D from Asylum Research (California, USA); optical characterization was performed on a Leica DM2500 fluorescence microscope.

The Raman microscope which we would be used for detecting analytes in the channels is a Jobin Yvon Horiba LabRAM in the confocal configuration (532 nm excitation) or a Renishaw spectrometer on an Olympus microscope (633 nm excitation). The Leica microscope mentioned above would be used for fluorescence or direct optical detection of inherently fluorescent or fluorescently-labelled or otherwise optically distinguishable entities within the channel.

### Example 1

### Preparation of a Multilayer Polymeric Device having Three Channels one of which has Periodic Barriers Protruding from Bottom

### 1a) Preparation of Micropatterned Stamp

A mold containing the inverse of the structural features for the stamp was printed on an acetate sheet using a standard laser printer. The mold was then placed into the bottom of a polycarbonate Petri dish from Fisher Scientific. This step is repeated several times until about 10 molds were placed in the Petri dish.

Onto the molds was poured 11 g of polydimethylsiloxane (PDMS) which was cured at a temperature of 60° C. for one hour. After the PDMS had cured, the micropatterned stamp was cut from the mold using a razor blade. This mold had three channels wherein the first channel was connected to two reservoirs, the second channel possessed bumps on its walls, while the third channel was straight.

### 1b) Application of Polymer Composition to Micropatterned Stamp and Curing of Polymer

Using a glass pipette, 20 mg of a high-viscosity polymer (NOA91, Norland Adhesives with a viscosity greater than 10,000 cps) was added to the surface of the stamp with three protruding lines, which was then placed on the glass substrate. The stamp was then pressed on the substrate with a force of about 5 Newtons for one second. The stamp was then allowed to rest on the substrate for 1 minute, at which point it was removed. The substrate with the transferred polymer was then cured under UV irradiation (5 minutes at 100 W, for example). The resulting device has three defined channels. Again using a glass pipette, 20 mg of a low-viscosity polymer (Sylgard 184, viscosity 5,000 cps) was applied to another stamp containing a series of holes, which was then placed on the first polymeric layer on the substrate. The stamp was then pressed on the substrate with a force of about 5 Newtons for one second. The stamp was then allowed to rest on the substrate for 1 minute, at which point it was removed. The substrate with the second polymer was then cured in an oven at 60° C. The resulting device possessed a series of protrusions which were deposited inside one of the channels. This process resulted in a multilayer polymeric device that was ready for use in an environmental assay.

### DISCUSSION

The protrusions of the device serve to increase the surface area in one channel relative to the others, allowing for different separation of components (cells, small beads, molecules, polymers, etc.) in different channels based on their relative flow rates through those channels. The channel possessing the protrusions serves to slow the passage of components, allowing for the resolution of faster flowing components. The other channels would allow for resolution between slower components. The speed of the components depends on their size and their affinity to the carrier solvent vs. the channel walls. Protrusions can also act as a filter so that larger objects get trapped within the protrusions.

### Example 2

### Application of Polymers to Micropatterned Stamp and Curing of Polymer

### 2a) Preparation of Micropatterned Stamp

A micropatterned stamp possessing a cross-hatched pattern was prepared using the method from Example 1a.

### 2b) Application of Polymer Composition to Micropatterned Stamp and Curing of Polymer

Using a glass pipette, 20 mg of a high-viscosity polymer (NOA91, Norland Adhesives with a viscosity greater than 10,000 cps) was added to the surface of the stamp possessing a cross-hatched pattern. The stamp was then pressed on the substrate with a force of about 5 Newtons for one second. The stamp was then allowed to rest on the substrate for 1 minute, at which point it was removed. The substrate with the transferred polymer was then cured under UV irradiation (5 minutes at 100 W, for example). Again using a glass pipette, 20 mg of a low-viscosity polymer (Sylgard 184, viscosity 5,000 cps) was applied to the stamp The stamp was then pressed on a substrate with a force of about 5 Newtons for one second. The stamp was then allowed to rest on the substrate for 1 minute, at which point it was removed. The substrate with the second polymer was then cured in an oven at 60° C.

FIG. 4 shows a micrograph showing of the cross-hatch pattern micropattern using a low-viscosity polymer. FIG. 5 shows a graph illustrating the cross-sectional profile of the height and width of the features of the micropattern in FIG. 4, using both the low-viscosity polymer of FIG. 4 and a high-viscosity polymer. Accordingly, the features of the micropattern produced using a low-viscosity polymer have a height of about 75 nm and a width of between about 30 and 40 μm, while the corresponding features of the micropattern using a high-viscosity polymer have a height of about 350 nm, and a narrower width of between about 20 and 30 μm, demonstrating that a higher viscosity polymer results in higher features and a higher resolution of those features

### Prophetic Example 3

### Environmental Assay

### 3a) Chemical Modification of Multilayer Polymeric Device

The first channel in the multilayer polymeric device that was produced in Example 1 is filled with a 5% solution of mercaptosilane (Sigma Aldrich) in ethanol (95%), which is then rinsed with 95% ethanol. This results in the first channel being functionalized with thiol groups.

### 3b) Immersion of the Chemically Modified Multilayer Device in a Stream

The device is then immersed into a stream to detect heavy metals which bind to the thiol functionalized first channel. The presence of heavy metals is readily detected using Raman spectroscopy, electrochemical means or the metals are optionally removed from the device and analyzed using mass spectroscopy.

### Prophetic Example 4

### Medical Assay for Detection of Steroids

### 4a) Chemical Modification of Multilayer Polymeric Device

Each of the channels in the multilayer polymeric device that was produced in Example 1 is filled with a solution of silanes of different functionality. By varying polarity, hydrogen-bonding capability, and conjugation between the channels, each will show different binding affinities to the analytes, thus differently affecting the rate of passage of the analytes through each channel.

4b) Immersion of the Chemically Modified Multilayer Device into a Bloodstream

The device is then exposed to urine which may or may not have been subjected to prior processing, filtering, or concentration, either through additional features on the chip or through standard laboratory methods. The presence of the analyte (steroids) is readily recognized by the signature of its positions within the three channels as detected spectroscopically.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR DOCUMENTS REFERRED TO IN THE SPECIFICATION

1. Gates, B. D. et al. Chem. Rev. 2005, 105, 1171.
2. Peeni, B. A. et al. Electrophoresis 2006, 27, 4888.
3. Wang, Y. et al. Anal. Chem. 2005, 77, 7539.
4. Bratton, D. et al. Polym. Adv. Technol. 2006, 17, 94.
5. Quist, A. P. et al. Anal. Bioanal. Chem. 2005, 381, 591.
6. Giboz, J. et al. J. Micromech. Microeng. 2007, 17, R96.
7. Xia, Y. et al. Microelectric Engineering 1996, 32, 255.
8. Melosh, N. A. et al. Science 2003, 300, 112.
9. Kumar, A. et al. Appl. Phys. Lett. 1993, 63, 2002.
10. Bao, N. et al. J. Chromatography A 2005, 1089, 270.

1. A method of depositing a polymer micropattern on a substrate, comprising:
a) applying a polymer composition to a stamp having a stamp micropattern thereon, so that the stamp micropattern is coated with the polymer composition;
b) contacting the stamp with a substrate and transferring the polymer composition from the stamp micropattern to the substrate, wherein the transferred polymer has a viscosity sufficient to form an uncured polymer micropattern comprising one or more uncured three-dimensional polymer features on the substrate, the uncured polymer micropattern corresponding to the stamp micropattern; and
c) curing the uncured polymer micropattern to form a cured polymer micropattern comprising one or more cured three-dimensional polymer features.

2. The method of claim 1, wherein the polymer composition has a viscosity of about 1,000 cps to about 15,000 cps.

3. (canceled)

4. The method of claim 2, wherein the polymer composition has a viscosity of about 10,000 to about 15,000 cps

5.-7. (canceled)

8. The method of claim 1, wherein the stamp micropattern comprises raised contact surfaces on the stamp for receiving polymer thereon for the formation of corresponding three-dimensional polymer features.

9. (canceled)

10. The method of claim 8, wherein the micro-scale or nano-scale features comprise a channel, a reservoir, a valve or an access port.

11. The method of claim 10, wherein the channels have a height of about 10 nm to about 100 mm.

12.-18. (canceled)

19. The method of claim 10, wherein the valves comprises a polymer layer having a closed position in which the layer blocks and seals a passage to channel and an open position in which the passage to the channel is open.

20. (canceled)

21. The method of claim 20, wherein the valves have a height of about 10 nm to about 100 nm.

22.-23. (canceled)

24. The method of claim 1, wherein the stamp micropattern comprises recesses for receiving polymer therein for the formation of corresponding three-dimensional polymer features.

25.-29. (canceled)

30. The method of claim to 1, wherein steps a)-c) are repeated on the same substrate.

31.-32. (canceled)

33. The method of claim 1, wherein the substrate comprises a glass slide, a quartz slide, a silicon wafer, a polycarbonate Petri dish, a silicone elastomer, another polymer film, or a micropatterned device fabricated in silicon, glass, or polymer.

34. The method of claim 1, wherein the polymer composition comprises a thermocurable polymer and the curing step comprises applying heat to the polymer.

35. The method of claim 34, wherein the thermocurable polymer comprises a silicone-based polymer.

36. (canceled)

37. The method of claim 35, wherein the silicone-based polymer comprises a mixture of methylhydrogen siloxane dimethyl, dimethylvinyl-terminated dimethyl siloxane, dimethylvinylated and trimethylated silica, tetra(trimethylsiloxy) silane and tetramethyl tetravinyl cyclotetrasiloxane or a mixture of dimethylvinyl-terminated dimethyl siloxane, hydrogen-terminated dimethyl siloxane, silicate and trimethylated silica.

38.-39. (canceled)

40. The method of claim 1, wherein the polymer composition comprises a photocurable polymer and the curing step comprises exposing the polymer to ultraviolet light.

41. The method of claim 40, wherein the photocurable polymer comprises an acrylate or a silicone elastomer.

42. The method of claim 41, wherein the acrylate comprises methacrylate.

43. The method of claim 41, wherein the silicone elastomer comprises a mixture of a siloxane pre-polymer, mercaptosiloxane and hydroxymethylphenyl propanone.

44.-46. (canceled)

47. The method of claim 1, wherein about 1 to about 30 mg of the polymer composition is applied to the stamp.

48.-52. (canceled)

53. The method of claim 1, wherein the polymer micropattern on the substrate comprises a micropatterned polymeric device.
